(19) United States
(12) Patent Application Publication
(10) Pub. No.: US 2025/0072534 A1
(43) Pub. Date: Mar. 6, 2025

(54) Illustrated Garments and Educational Guides

(71) Applicant: Educate, LLC, Fort Myers, FL (US)

(72) Inventor: Julie LOTZ, Fort Myers, FL (US)

(21) Appl. No.: 18/818,558

(22) Filed: Aug. 28, 2024

Related U.S. Application Data
(60) Provisional application No. 63/535,296, filed on Aug. 29, 2023.

(51) Int. Cl. A41D 10/00; A63F 1/02; G06F 16/955

(52) U.S. Cl. CPC A41D 10/00; A63F 1/02; G06F 16/9554; A41D 2600/00

(57) ABSTRACT

Example systems and methods are described for facilitating education and play using a garment and a guide. The garment includes an illustration that is related to an educational theme. The guide includes indicia that is also related to the educational theme. The garment illustration cooperates with the guide indicia to facilitate play and education. The educational theme is based on traits such as age, grade level, and reading ability. An example garment includes a set of pajamas imprinted with the illustration. An example guide includes a set of cards bearing indicia, such as images, and text. An example method includes developing a learning schedule in accordance with each educational theme and establishing a subscription based on the learning schedule.

### CROSS REFERENCE TO RELATED APPLICATIONS

The present application claims the benefit of and priority to U.S. Provisional Application 63/535,296 filed Aug. 29, 2023, entitled, “Illustrated Garments and Related Printed Indicia for Facilitating Education and Play.” The entirety of the identified provisional application is incorporated herein by reference.

### TECHNICAL FIELD

Examples set forth in the present disclosure relate to wearable garments for facilitating education and play. More particularly, but not by way of limitation, the present disclosure describes garments that include illustrations related to an educational theme, together with one or more guides such as flash cards bearing indicia also related to the educational theme.

### BACKGROUND

Bedtime in many families is a unique opportunity for parent-child interaction. The bedtime story is a traditional form of storytelling which can have a positive impact on children of all ages. Reading aloud to a child at bedtime offers multiple benefits, both social and educational. A story book can serve as a play resource and a guide for learning.

### BRIEF DESCRIPTION OF THE DRAWINGS

Features of the various implementations disclosed will be readily understood from the following detailed description, in which reference is made to the appending drawing figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to-scale unless otherwise indicated. The dimensions of the various elements may be enlarged or reduced in the interest of clarity. The several figures depict one or more implementations and are presented by way of example only and should not be construed as limiting. Included in the drawings are the following figures:

FIG. 1 is an illustration of an example system, including an example garment with illustrations being worn by a student who is holding an example guide;

FIG. 2 is an illustration of an example guide that includes a set of cards bearing indicia;

FIG. 3A is an illustration of an example set of cards, showing the front side;

FIG. 3B is an illustration of the example set of cards shown in FIG. 2A, showing the back side; and

FIG. 4 is a flow chart listing a series of steps in an example method of designing, creating, developing, and distributing an example system.

### DETAILED DESCRIPTION

The present systems and apparatuses and methods are understood more readily by reference to the following detailed description, examples, drawings, and claims. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

Like parts are marked throughout the following description and drawings with the same reference numerals or names. The drawings may not be to-scale and certain features may be shown exaggerated in scale or in somewhat schematic format in the interest of clarity, conciseness, and to convey information.

The following detailed description includes numerous details and examples that are intended to provide a thorough understanding of the subject matter and its relevant teachings. Those skilled in the relevant art may understand how to apply the relevant teachings without such details. This disclosure is not limited to the specific devices, systems, and methods described because the relevant teachings can be applied or practiced in a variety of ways. The terminology and nomenclature used herein is for the purpose of describing particular aspects only and is not intended to be limiting.

Those skilled in the relevant art will recognize and appreciate that many changes can be made to the various aspects of the implementations described herein, while still obtaining a variety of beneficial results. It will also be apparent that some of the desired benefits can be obtained by selecting some of the features, but not others. Accordingly, those who work in the art will recognize that many modifications and adaptations are possible and may even be desirable in certain applications, and that these are part of the disclosure.

The terms “comprising” and “including,” and any forms thereof, are intended to indicate a non-exclusive inclusion; that is, to encompass a list that includes the items listed and may include others not expressly listed.

As used herein, the singular forms “a,” “an” and “the” include plural referents unless the context clearly dictates otherwise. Thus, for example, reference to a component can include two or more such components unless the context indicates otherwise.

The terms “optional” or “optionally” mean that the subsequently described element or action may or may not occur. In other words, such a description includes instances where the element or action occurs and instances where it does not.

As used herein, the term “facilitate” means to aid, assist, enable, improve, or make easier. The term “inhibit” means to hinder, restrain, impede, restrain, thwart, oppose, or obstruct.

Various implementations and examples are described herein with reference to systems and methods for facilitating education and play. Although the various examples are described with reference to an example garment 100 (e.g., pajamas) and an example guide 200 (e.g., a set of cards printed on card stock), the methods and systems described herein may be applied in a variety of contexts, including any type of garment and any type of guide, whether printed on cards or provided through another medium.

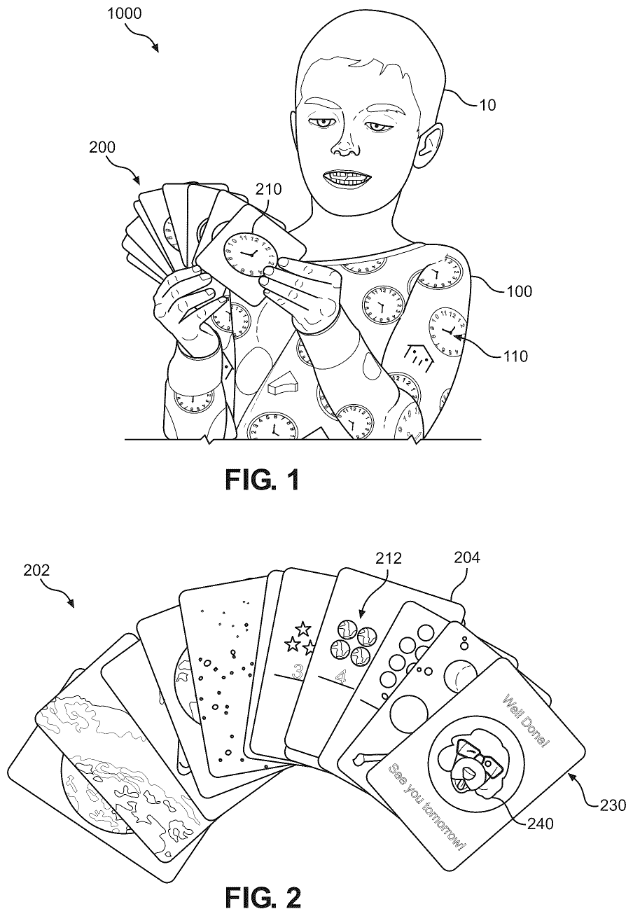

FIG. 1 is an illustration of an example system 100 for facilitating education and play. The system, in some implementations, includes a garment 100 and a guide 200. The garment 100 includes an illustration 110 that is related to an educational theme 120 (e.g., numbers, animals). The guide 200 includes indicia 210 that is also related to the education theme 120. In some implementations, the garment illustration 110 cooperates with the guide indicia 210 to facilitate play and the education of a student. FIG. 1 shows an example garment 100 (e.g., a pajama top) with illustrations 110 (e.g., clocks) being worn by a student 10 who is holding an example guide 200 (e.g., a set of cards) bearing indicia (e.g., clock faces).

The garment 110 in some implementations includes a pajama set 102 (e.g., a two-piece set with a top and coordinated pants). The illustration 110 in some implementations are applied or printed onto one or both pieces of the garment 100. The garment 100 in some implementations includes a selectively removable piece (e.g., a patch, band, or belt; not shown,) and a supplemental garment (e.g., a robe, jacket, or other accessory). The garment 100 in some implementations is machine-washable and made from any of a variety of suitable fabrics (e.g., cotton, cotton-based blend, 100% GOTS-certified organic cotton). The term “garment” as used herein means and includes any item of clothing and any other wearable item or device, whether used to clothe or cover the body or as an accessory.

The illustration 110 in some implementations is printed on, woven into, or otherwise applied to the garment 100. In some implementations, the illustration 110 is created based on the age group of the child or student. Each illustration 110 is a work of art related to an educational theme 120. Any of a variety of illustrations 110 may be created by artists or others which are related to the educational theme 120. In some implementations, the illustration 110 is separate or selectively removable from the garment 100.

The educational theme 120 in some implementations includes content created and developed by teachers, educators, and other experts. In some implementations, the educational theme 120 is selected and developed according to educational standards, milestones, and other references.

In some implementations, the educational theme 120 is correlated with a particular type of student based on one or more traits 150, including but not limited to age, intellectual ability, grade level in school, and reading comprehension.

The guide 200 in some implementations includes a set 202 of one or more cards 204 (e.g., known as Smart Dreams™ cards,) which may be made of paper, card stock, or other suitable material. In some implementations, each card 204 is made from a coated, matte finish, card stock, having a size of three inches by 4.25 inches, with rounded edges for safety and durability. The set 202 in some implementations includes twelve (12) or more educational cards 204 and one or more select cards (e.g., known as Cooper Cards) bearing an encouraging message 230 that is inspirational, uplifting, or fun (e.g., not necessarily educational). FIG. 2 is an illustration of an example set 202 of cards 204 bearing indicia 210 (e.g., an illustration 212, as shown). The example set 202 in FIG. 2 includes an encouraging message 230 (e.g., “Well done!”) and a mascot 240 on a Cooper Card.

In some implementations, the quantity of cards in the set 202 will vary depending on the educational theme 120, on the amount of information or other indicia 210 to be conveyed, and on customer feedback. The set 202 of cards 204 in some implementations is sold, shipped, or otherwise provided in a shrink-wrapped bundle along with a container 220 (e.g., a drawstring bag) for storage and safekeeping. Any of the cards 204 may be collectible and may function as a keepsake. The term “set of cards” as used herein means and includes any type of card and any other type of medium for conveying information, whether accessible by holding a physical item or by accessing the information electronically (e.g., including a scannable code 170 or other type of link to the internet).

The indicia 210 or information on the set 202 of cards in some implementations is closely related to illustration 110 on the garment 100. In some implementations, both the illustration 110 and the indicia 210 are associated with the educational theme 120. In some implementations, the illustration 110 on the garment 100 is mostly or primarily decorative, (e.g., colorful geometric shapes,) and the indicia 210 is mostly or primarily educational (e.g., names or information about shapes and colors). In this example, the indicia 210 primarily conveys the education theme 120 while still being coordinated with the illustration 110. In other implementations, the indicia 210 on the guide 200 is mostly or primarily decorative, (e.g., cards bearing a variety of colorful, geometric shapes,) and the illustration 110 on the garment 100 is mostly or primarily educational (e.g., names for shapes and colors printed on the garment 100). In this example, the illustration 110 primarily conveys the educational theme 120 while still being coordinated with the indicia 210. In this aspect, the educational content associated with the theme 120 may be conveyed primarily by the illustration 110, by the indicia 210, or both, in various combinations.

The term “indicia” as used herein means and includes any combination of letters, words, text, numbers, symbols, diagrams, information, images, pictures, photographs, trademarks, and graphics, in any of a variety of colors, fonts, and artful presentations. The indicia 210 in some implementations is printed on or otherwise applied to the cards 204. In some implementations, like the illustration 110 printed on the garment 100, the indicia 210 are designed and created based on the age group of the child or student. Each part of the indicia 210 is a work of art that includes content created and developed by artists, teachers, educators, and other experts.

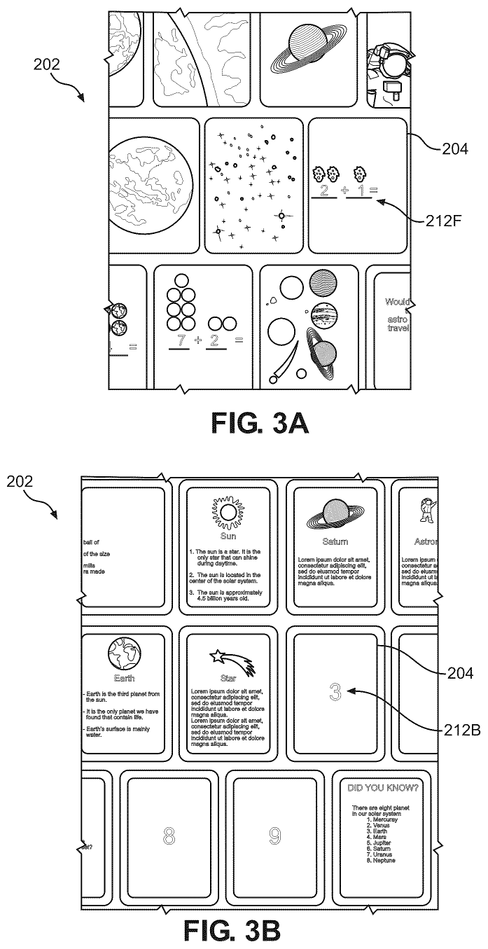

In some implementations, one or more cards 204 in a set include indicia 210 printed on both sides. FIG. 3A is an illustration of an example guide 200 that includes cards 204 bearing indicia 210 on the front side. As shown, the indicia 210 includes a front-side illustration 212F (e.g., a mathematical equation). FIG. 3B is an illustration of the cards 204 bearing indicia 210 on the back side. As shown, the indicia 210 includes a back-side illustration 212B (e.g., a solution to the mathematical equation on the front side). In this example, the illustrations include a problem or question printed on the front face of the card (e.g., illustration 212F), and a related solution or answer printed on the back face of the card (e.g., illustration 212B). In this aspect, one or more cards 204 in the set 202 operate like flash cards.

The indicia 210 in some implementations includes information related to one or more types of content types 160, including but not limited to illustrations, facts, flash cards, problem statements, activity prompts, games, and operable links to other resources. For example, the indicia 210 in some implementations include a code 170, a scannable element, or other operable link that will guide the user to content on the internet or content stored on an electronic device, such as a smartphone, laptop, tablet, watch, or other device.

In some implementations, the indicia 210 is programmed into or otherwise found on a mobile application 206 that is configured to cooperate with the garment 100 and the illustration 110. In some implementations, the indicia 210 includes a set 202 of cards 204 and additional material on the mobile application 206, such that the cards 204 and the application 206 cooperate to deliver and display the indicia 210.

In another aspect, a mobile application 206 may be configured to scan a code 170, a scannable element, or other operable link, which may be found in the garment illustration 110 and/or in the guide indicia 210. Scanning such a code 170 in some implementations directs the parent or other user to auxiliary information that is related to the educational theme 120. Such auxiliary information may include web pages, instructions for the parent, guides for leading a discussion, additional or different illustrations, information that is more advanced than the garment illustration 110 or the guide indicia 210, suggested books to read, and any of a variety of other materials related to the educational theme 120.

In some implementations, the garment illustration 110 and/or the guide indicia 210 are not necessarily educational. For example, the systems and methods described herein may include holiday editions (e.g., Halloween, Christmas), theme-based editions (e.g., associated with seasons, events, milestones, or products such as books), special editions that are primarily artistic, or other special editions.

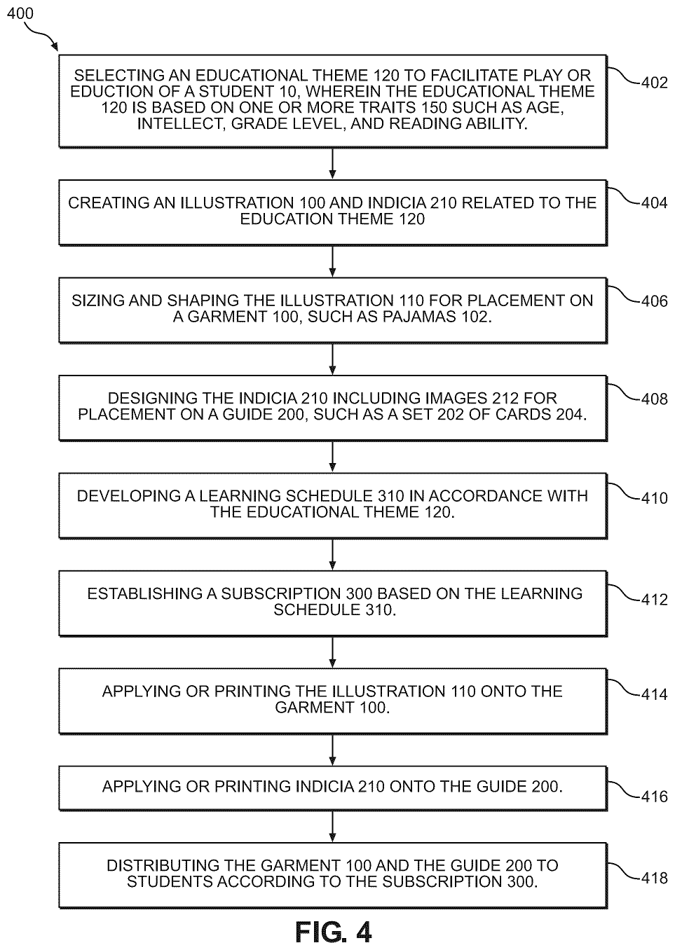

FIG. 4 is a flow chart 400 listing a series of steps in an example method of designing, creating, developing, and distributing systems, such as those described herein. One or more of the steps shown and described in FIG. 4 may be performed simultaneously, in a series, in an order other than shown and described, or in conjunction with additional steps. Some steps may be omitted or, in some applications, repeated.

Block 402 describes an example step of selecting an educational theme 120 to facilitate play or education of a student 10. The educational theme 120 in some implementations is based on one or more traits 150 such as age, intellect, grade level, and reading ability. The educational theme 120 in some implementations includes content created and developed by teachers, educators, and other experts. Of course, a number of educational themes 120 may be selected and developed according to various goals, educational standards, learning milestones, and other reference points in childhood development. In this aspect, the process of selecting an educational theme 120 includes selecting and developing a variety of educational themes 120 for different purposes.

Block 404 describes an example step of creating an illustration 100 and indicia 210 related to the education theme 120.

Block 406 describes an example step of sizing and shaping the illustration 110 for placement on a garment 100, such as pajamas 102. Any of a variety of illustrations 110 may be created by artists or others, in a variety of patterns and colors. The process of generating the illustration 100 in particular sizes and shapes depends on the garment 100, the overall design, and the number and variety of elements in the illustration 100.

Block 408 describes an example step of designing the indicia 210 for placement on a guide 200, such as a set 202 of cards 204. The indicia 210, as described herein, in some implementations, includes one or more images 212 (e.g., clock faces, planets, mathematical expressions) which are designed to cooperate with the illustration 110 on the garment 100. The process of designing the indicia 210 includes selecting particular size and shapes, depending on the guide 200 (e.g., cards 204 having a particular size and shape).

Block 410 describes an example step of developing a learning schedule 310 in accordance with the educational theme 120. The process of developing a learning schedule 310 in some implementations includes developing a particular learning schedule 310 that is tailored to each of a variety of educational themes 120. The schedule 310 and themes 210 in some implementations are developed together, according to particular teaching goals, educational standards, learning milestones, and other factors. For example, an educational theme 210 about the solar system might be associated with a learning schedule 310 of eight weeks. An educational theme 210 about the alphabet might be associated with a learning schedule 310 of twenty weeks.

Block 412 describes an example step of establishing a subscription 300 based on the learning schedule 310. In some implementations, the system described herein are offered as a subscription 300, including a garment 100 and a corresponding guide 200, to be delivered several times a year, based on the learning schedule 310 developed in accordance with each particular educational theme 120. The schedule 310 in some implementations is controlled by a parent, relative, guardian, teacher, or other person who selects one or more of the next or previous editions in a collection.

Block 414 describes an example step of manufacturing, making, or otherwise selecting the garment 100, including the process of applying or printing the illustration 110 onto the garment 100.

Block 416 describes an example step of manufacturing or making, or otherwise selecting the guide 200, including the process of applying or printing the indicia 210 onto the guide 200.

Although several embodiments have been described herein, those of ordinary skill in the art, with the benefit of the teachings of this disclosure, will understand and comprehend many other embodiments and modifications for this technology. The invention therefore is not limited to the specific embodiments disclosed or discussed herein, and that many other embodiments and modifications are intended to be included within the scope of this disclosure.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in the claims. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to recite any and all modifications and variations that fall within the true scope of the present disclosure.

What is claimed is:

1. A system, comprising:
a garment comprising an illustration related to an educational theme; and
a guide bearing indicia associated with the educational theme, such that the indicia and the illustration cooperate to facilitate play or education of a student.

2. The system of claim 1, wherein the educational theme is correlated with the student based on one or more traits selected from a trait group consisting of age, intellect, grade level, and reading ability.

3. The system of claim 1, wherein the garment comprises a pajama set characterized by a top and coordinated pants.

4. The system of claim 1, wherein the garment comprises one or more of a selectively removable piece, a supplemental garment, and an accessory.

5. The system of claim 1, wherein the guide comprises a set of cards,
wherein the indicia comprise one or more images printed on at least one side of one or more cards in the set, and
wherein the set comprises at least one select card bearing at least one of an encouraging message or a mascot.

6. The system of claim 1, wherein the indicia on the guide include one or more content types selected from a content group consisting of illustrations, facts, flash cards, questions and answers, problem statements, activity prompts, games, scannable codes, and operable links to other resources.

7. The system of claim 1, comprising a container sized and shaped to hold or store the guide.

8. The system of claim 1, wherein at least one of the garment or the guide comprises a scannable code 170 that facilitates a link to the Internet.

9. The system of claim 1, wherein the guide comprises a mobile application for delivering the indicia.

10. A method comprising:
selecting an educational theme;
creating an illustration and indicia related to the educational theme;
sizing and shaping the illustration for placement on a garment;
designing the indicia for placement on a guide; and
providing the garment and the guide together, such that the illustration and the indicia cooperate to facilitate play or education associated with the educational theme.

11. The method of claim 10, wherein selecting the educational theme comprises:
correlating the educational theme with a student based on one or more traits selected from a trait group consisting of age, intellect, grade level, and reading ability.

12. The method of claim 10, wherein the guide comprises a set of cards, and wherein designing the indicia comprises:
creating one or more images;
sizing and shaping the one or more images for placement on the set of cards; and
generating a select card for which the one or more images includes at least one of an encouraging message or a mascot.

13. The method of claim 12, wherein designing the indicia comprises:
creating a front-side image for placement on a front face of a flash card in the set; and
creating a back-side image that corresponds to the front-side image, wherein the back-side image is placed on the back face of the flash card.

14. The method of claim 10, comprising:
manufacturing the garment;
printing the illustration on the garment;
printing the indicia on the guide; and
sizing and shaping a container to hold the guide.

15. The method of claim 10, comprising:
developing a learning schedule in accordance with the educational theme;
establishing a subscription based on the learning schedule; and
distributing the garment and the guide together according to the subscription.

16. The method of claim 10, comprising:
selecting the garment bearing the illustration;
selecting the guide based on whether the indicia is related to the illustration;
donning the garment; and
viewing at least one of the indicia on the guide or the illustration on the garment.

17. The method of claim 16, comprising:
viewing the indicia and the illustration with another person selected from a mentor group consisting of a parent, a sibling, a friend, a teacher, and a mentor.
